(19) United States
(12) Patent Application Publication
(10) Pub. No.: US 2011/0042634 A1
(43) Pub. Date: Feb. 24, 2011

(54) TETHER HOIST SYSTEMS AND APPARATUSES

(76) Inventor: Richard William Boychuk, Toronto (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/858,511

(22) Filed: Aug. 18, 2010

Related U.S. Application Data
(60) Provisional application No. 61/234,840, filed on Aug. 18, 2009.

(51) Int. Cl. B66D 1/28; B66D 1/60; B66D 1/26; B66D 1/36; B66D 1/12; F16B 1/00

(52) U.S. Cl. 254/286; 254/266; 254/278; 254/294; 254/362; 403/166

(57) ABSTRACT

A rigging system for raising and lowering a load includes at least one tether suspended between first and second spaced apart connection points. A hoist apparatus is selectively movable along the at least one tether and is coupled to the load so that movement of the hoist apparatus causes the raising and lowering of the load. The hoist apparatus can include drive pulleys and guide pulleys. A connection apparatus for connecting a tether to a fixed surface includes a base plate, a spring mechanism, at least at least one end plate, and a bushing member coupling the second end of the spring mechanism to the end plate. Tension on the tether causes the spring mechanism to compress and reduce distance between the end and base plates.

### CROSS REFERENCE TO RELATED APPLICATION

This application claims the benefit of U.S. Application No. 61/234,840 filed Aug. 18, 2009, which is hereby incorporated by reference in its entirety.

### FIELD

This specification relates to rigging systems, apparatuses and related hardware.

### BACKGROUND

The following paragraphs are not an admission that anything discussed in them is prior art or part of the knowledge of persons skilled in the art.

U.S. Pat. No. 5,996,970 (Auerbach) discloses a motorized assist counterweight system for theatrical overhead rigging.

U.S. Pat. No. 7,264,228 (Kaiser et al.) discloses a counterweight assisted winch.

U.S. Pat. No. 7,275,733 (Svitaysky et al.) discloses a compact drive for a counterweight assisted winch.

### INTRODUCTION

In an aspect of this specification, a rigging system for raising and lowering a load can comprise: at least one tether suspended between first and second spaced apart connection points; a hoist apparatus, the hoist apparatus including a housing and a drive mechanism disposed within the housing, the drive mechanism coupled to the at least one tether, the hoist apparatus being selectively movable along the at least one tether by operation of the drive mechanism; and at least one connection line coupling the hoist apparatus and the load such that movement of the hoist apparatus towards and away from the first connection point respectively causes the raising and lowering of the load.

In an aspect of this specification, a connection apparatus for connecting a tether to a fixed surface can comprise: a base plate coupled to the fixed surface, the base plate including a first side surface and an aperture extending through the base plate; a spring mechanism including first and second ends and defining a longitudinal axis between the first and second ends, the first end configured to bear against the first side surface of the base plate, the second end positioned spaced apart from the base plate so that the longitudinal axis is in general alignment with the aperture; and at least one end plate arranged adjacent to the second end of the spring mechanism and coupled to the tether, the tether extending from the at least one end plate through the spring mechanism and the aperture, wherein tension on the tether causes the spring mechanism to compress and reduce distance between the end and base plates.

Other aspects and features of the teachings disclosed herein will become apparent, to those ordinarily skilled in the art, upon review of the following description of the specific examples of the specification.

### DRAWINGS

The drawings included herewith are for illustrating various examples of systems, apparatuses and methods of the present specification and are not intended to limit the scope of what is taught in any way. In the drawings:

FIG. 1 is a schematic diagram of a tether hoist system;

FIG. 2 is a perspective view of a hoist apparatus and tethers;

FIGS. 3A and 3B are front and right side views, respectively, of the hoist apparatus and tethers shown in FIG. 2;

FIGS. 4A, 4B, 4C and 4D are schematic views of various configurations of hoist apparatuses and tethers;

FIG. 5 is a see-thru perspective view of the hoist apparatus shown in FIG. 2;

FIGS. 6A and 6B are exploded side and front views, respectively, of a connection apparatus;

FIG. 6C is an exploded perspective view of the connection apparatus shown in FIGS. 6A and 6B and a tether;

FIG. 6D is a side view of the connection apparatus shown in FIGS. 6A and 6B assembled with a tether; and

FIGS. 7A, 7B and 7C are side, top and front views of an assembly of connection apparatuses.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. The applicants, inventors or owners reserve all rights that they may have in any invention disclosed in an apparatus or process described below that is not claimed in this document, for example the right to claim such an invention in a continuing application and do not intend to abandon, disclaim or dedicate to the public any such invention by its disclosure in this document.

Counterweight rigging systems are typically used on live performance stages as a means of counterbalancing the changing weights of different scenery or lighting battens, which can become heavier or lighter as scenery or lighting fixtures are added or removed.

Rigging in a stage environment can be automated and operated with motors. Generally, motorized rigging systems use a motor and drum configuration. A length of travel of the hoisted load results in an amount of cable that must be stored. The cable is typically stored onto a drum that is fabricated with a spiral groove for receiving the cable. The drum can be of a significant diameter as to meet the generally accepted requirements of 30:1, which means that the diameter of the drum is to be 30 times the diameter of the cable. Cables used in this application are typically 3/16″ or ¼″ in diameter. This results in drum diameters of about 6 inches and 8 inches. The relatively large diameter of the drum increases the torque required to hoist a load. Furthermore, the weight of the drum and related equipment is not being directly used to assist with hoisting.

Applicant's teachings relate to a tether hoist system that can be used as a rigging system. The tether hoist system includes a least one tether that extends between two fixed points, and a hoist apparatus that is selectively movable along the at least one tether by operation of a drive mechanism. The hoist apparatus can be coupled to a load with a connection line to raise and lower the load. The hoist apparatus can also include a plurality of drive and guide pulleys that enable the hoist apparatus to be coupled with more than one tether. Applicant's teachings also relate to a connection apparatus that can be used to connect a tether to a fixed surface.

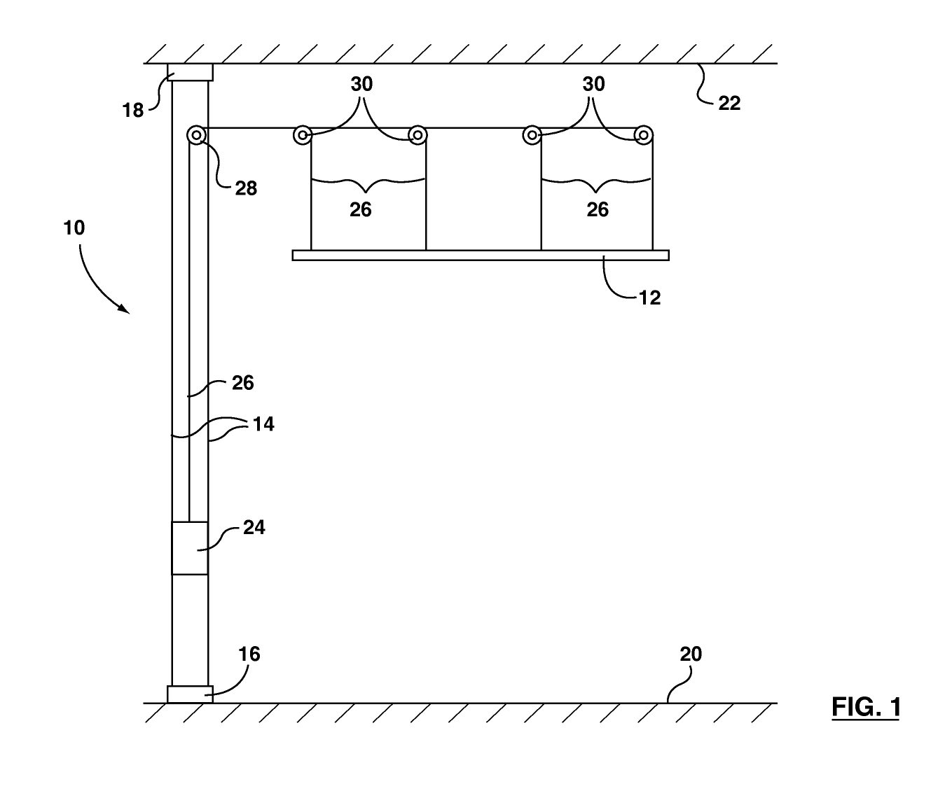

Referring to FIG. 1, shown generally at 10 is a rigging system for raising and lowering a load 12. The load 12 can include a batten. The system 10 can include at least one tether 14 suspended generally vertically between first and second spaced apart connection points 16, 18. The first connection point 16 can be provided along foot structure 20. The second connection point 18 can be provided along head structure 22. The first connection point 16 can be integral with the foot structure 20 or can be a separate structure fixed to the foot structure 20. Similarly, the second connection point 18 can be integral with the head structure 22 or can be a separate structure fixed to the head structure 22.

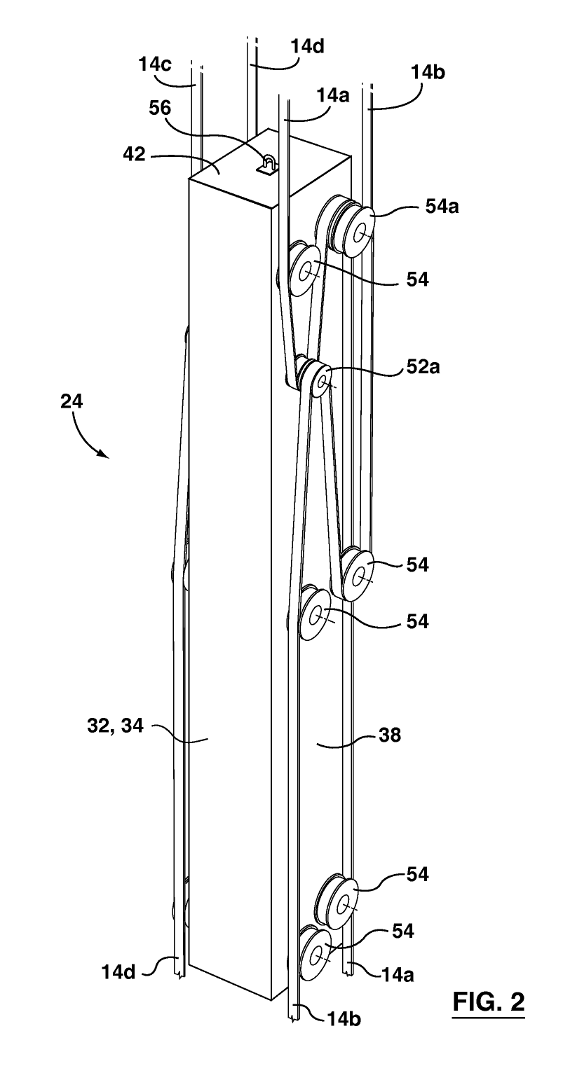

The system 10 further includes a hoist apparatus 24. The hoist apparatus 24 is selectively movable along the at least one tether 14 between the connection points 16, 18 by operation of a drive mechanism, which is described in further detail below. The at least one tether 14 is coupled to the hoist apparatus 24 so that weight of the hoist apparatus 24 and the load 12 can be transferred to the foot and head structures 20, 22. Referring to FIG. 2, an example of a hoist apparatus 24 is shown in combination with first, second, third and fourth tethers 14a, 14b, 14c, 14d.

Referring again to FIG. 1, at least one connection line 26 couples the hoist apparatus 24 and the load 12. The connection line 26 may also be referred to as a loft line. By means of the connection line 26, movement of the hoist apparatus 24 towards and away from the first connection point 16 respectively causes the raising and lowering of the load 12. In some examples, the connection line 26 is supported, intermediate the hoist apparatus 24 and the load 12, by at least one head block 28 and at least one loft block 30. Although the system 10 with the connection line 26 is illustrated in a single purchase configuration, it should be appreciated that a double purchase configuration is possible.

Weight of the hoist apparatus 24 can serve to counterbalance weight of the load 12, and thus assist in raising and lowering of the load 12. If the system 10 is unbalanced and the load 12 is heavier than the hoist apparatus 24, the hoist apparatus 24 must be driven down the tether 14 to raise the load 12. If the system 10 is unbalanced and the hoist apparatus 24 is heavier than the load 12, the hoist apparatus 24 must be driven up the tether 14 to lower the load 12. If the system 10 is balanced and the load 12 weighs the same as the hoist apparatus 24, the hoist apparatus 24 can be driven up or down with relatively little power required, i.e. enough to overcome inertia. If the hoist apparatus 24 is disconnected from the load 12, the hoist apparatus 24 will be moving its own weight up and down the tether 14.

The hoist apparatus 24 therefore can be only generally required to hoist the difference between the weight of the load 12 and the weight of the hoist apparatus 24 itself. For example, if the load 12 has a weight of 1,000 pounds and the hoist apparatus 24 has a weight of 500 pounds, the hoist apparatus 24 need only to be rated at about 500 pounds and yet is able to hoist a load of 1,000 pounds.

It is possible to actively counterbalance the load 12 by adding or subtracting weight from the hoist apparatus 24 or from the load 12 itself. Thus, when there is an imbalance of, for example, 400 pounds in favor of the hoist apparatus 24, 400 pounds of “ghost load” can be added to the load 12 resulting in a generally balanced system 10 in which the hoist apparatus 24 is only required to overcome inertia when either the system 10 is stationary and movement is desired, or when the system 10 is in motion and it is desired to stop.

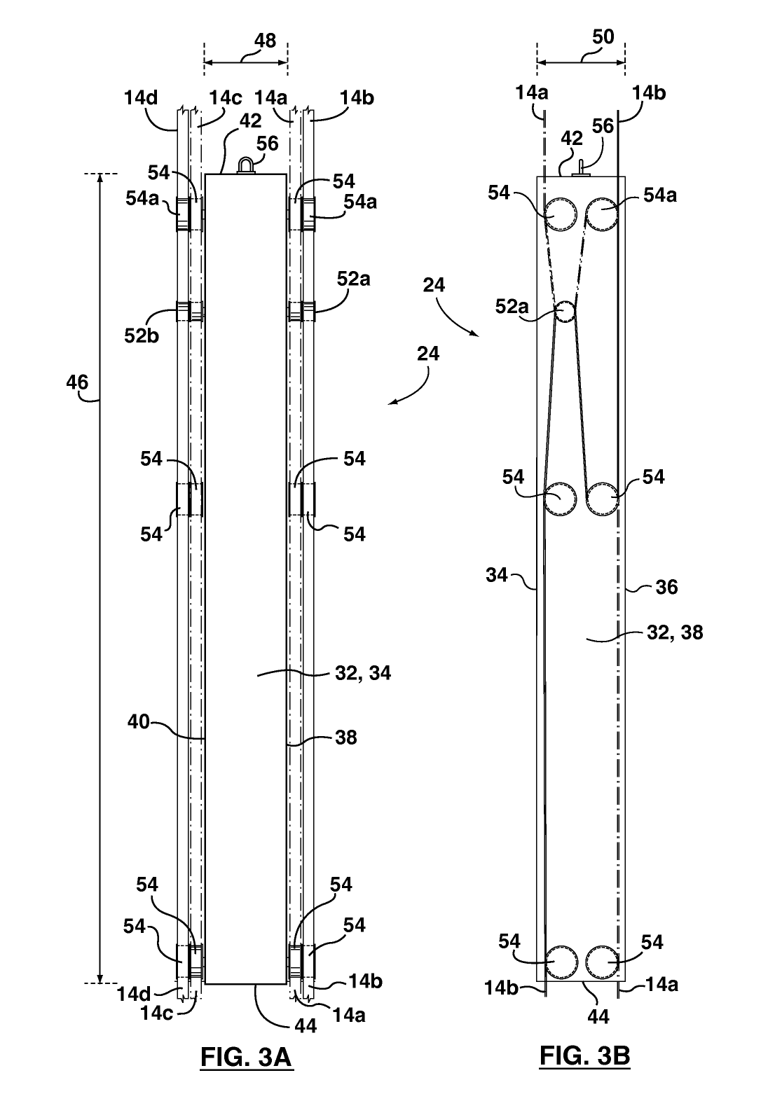

Referring to FIGS. 2, 3A and 3B, the hoist apparatus 24 is shown in combination with first, second, third and fourth tethers 14a, 14b, 14c, 14d. The tethers 14a, 14b, 14c, 14d can be spaced apart, extend generally vertically and arranged generally in parallel to one another. The hoist apparatus 24 can include a housing 32 that can generally define front, rear, right, left, top and bottom sides 34, 36, 38, 40, 42, 44. Distance between the top and bottom sides 42, 44 defines a height dimension 46, and distance between the right and left sides 38, 40 defines a width dimension 48 (FIG. 3A). Distance between the front and rear sides 34, 36 defines a depth dimension 50 (FIG. 3B). It should be appreciated that while the housing 32 is illustrated defining a generally cuboidal shape, a cuboidal shape is not essential for the hoist apparatus 24 and other shapes are possible.

The hoist apparatus 24 can also include first and second drive pulleys 52a, 52b that extend outwardly from the right and left sides 38, 40 of the housing 32, respectively. The first drive pulley 52a is operably connected to the first and second tethers 14a, 14b, which extend along the right side 38 of the housing 32. The second drive pulley 52b is operably connected to the third and fourth tethers 14c, 14d, which extend along the left side 40 of the housing 32. The drive pulleys 52a, 52b can include separate, adjacent sheaves for connecting to the respective tethers.

The hoist apparatus 24 can further include a plurality of guide pulleys 54 mounted on the right and left sides 38, 40 of the housing 32. Each of the guide pulleys 54 can be configured to receive and operably connect with at least one of the tethers 14a, 14b, 14c, 14d. The guide pulleys 54a can be configured as double pulleys and operably connect with two of the tethers 14a, 14b, 14c, 14d. The hoist apparatus 24 can yet further include an attachment means 56 for attaching the connection line 26.

With continued reference to FIG. 3B, at least a portion of the guide pulleys 54 can be arranged laterally offset relative to the drive pulley 52a (i.e. closer to the front or rear sides 34, 36), so that the guide pulleys 54 maintain the first and second tethers 14a, 14b spaced apart from one another above and below the hoist apparatus 24. The first and second tethers 14a, 14b are shown above the top side 42 of the housing 32 spaced apart and generally parallel, and similarly the first and second tethers 14a, 14b are also shown below the bottom side 44 of the housing 32 spaced apart and generally parallel, but in a switched configuration. In other words, the first tether 14a extends along a first linear path above the hoist apparatus 24 that is generally parallel to the second tether 14b below the hoist apparatus 24, and the second tether 14b extends along a second linear path above the hoist apparatus 24 that is generally parallel to the first tether 14a below the hoist apparatus 24. The third and fourth tethers 14c, 14d can be arranged on the opposing left side 40 in a generally mirror image relationship relative to the first and second tethers 14a, 14b on the right side 38.

It should be appreciated that the use of four tethers 14 can provide for a relatively stable, rigid configuration. Furthermore, the use of four tethers 14 can serve as a safety feature if each of the tethers 14 are selected to have a strength rating that meets or exceeds the weight requirements demanded by the load 12 and the hoist apparatus 24. Should one of the tethers fail, the other three tethers can continue to support the hoist apparatus 24.

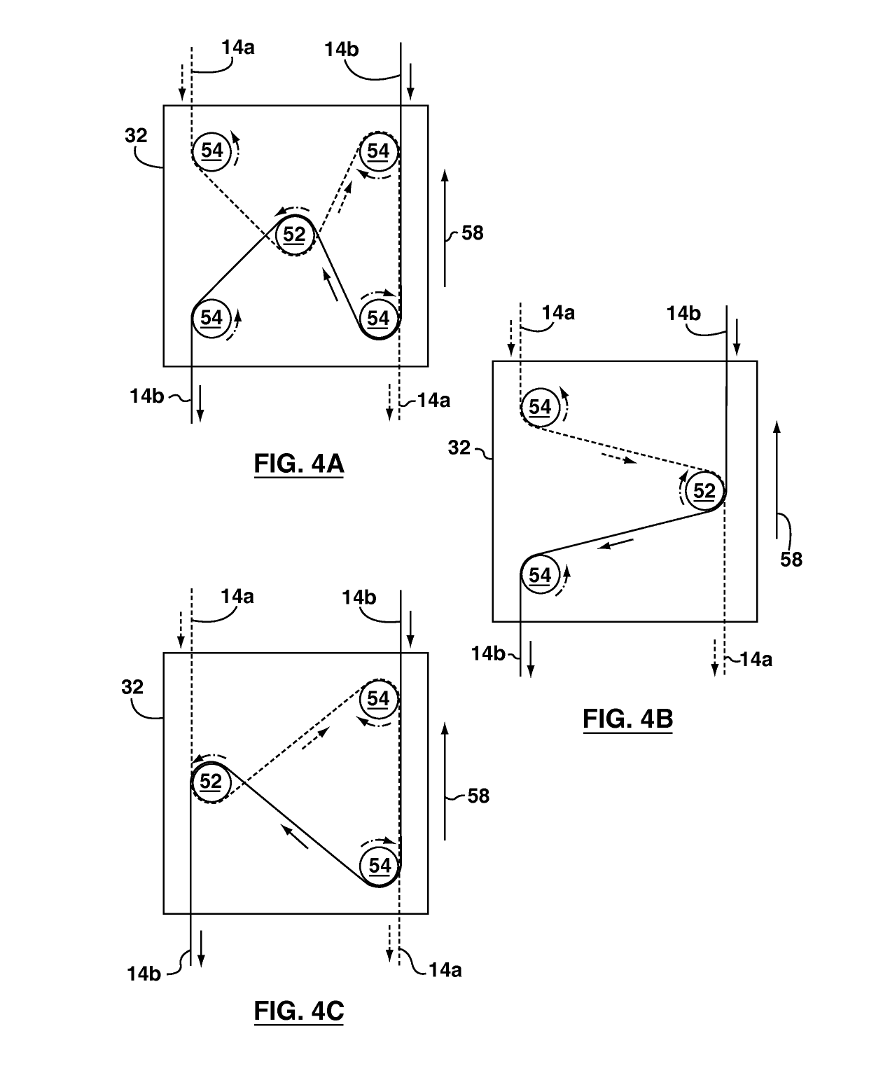

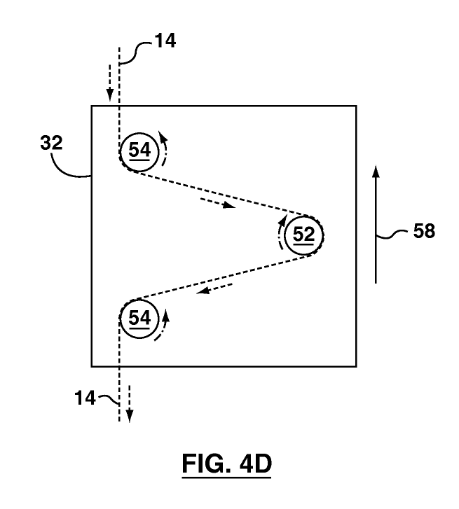

FIGS. 4A, 4B and 4C illustrate some examples of configurations of the drive and guide pulleys 52, 54. In each example, at least a portion of the guide pulleys 54 are arranged laterally offset relative to the drive pulley 52 so that the guide pulleys 54 maintain the tethers 14a, 14b spaced apart from one another above and below the housing 32. The arrows illustrate the direction of travel of the tethers 14a, 14b and the drive and guide pulleys 52, 54 relative to a hoisting direction 58.

FIG. 4D illustrates another example configuration, with the drive and guide pulleys 52, 54 located in a similar position to that which is shown in FIG. 4B. However, only a single tether 14 is provided. The arrows illustrate the direction of travel of the tether 14 and the drive and guide pulleys 52, 54 relative to a hoisting direction 58. This configuration can be implemented in examples with only two tethers, instead of four, with the tethers provided on generally opposing sides of the housing 32, and in mirror image to one another. Other configurations are possible.

It may be desirable to install the system 10 as a “retrofit” to replace an existing manual counterweight rigging system. Typically, manual counterweight rigging systems employ arbors for supporting counterweights having standardized dimensions. For this reason, in some examples, the housing 32 of the hoist apparatus 24 can be sized and shaped to be similar to that of known arbors. For example, the width dimension 48 can be between 12 and 16 inches (e.g., about 14 inches) and the depth dimension 50 can be between 6 and 10 inches (e.g., about 8 inches).

The tethers 14 and the drive pulleys 52 are formed of a suitable construction to enable positive traction between the tethers 14 and the drive pulleys 54. In some examples, the tethers 14 can take the form of a toothed rubber band with reinforcing metallic cable disposed internally. In some examples, the tethers 14 can take the form of rubber-encased wire cable. In some examples, the tethers 14 can take the form of metallic chain. In some examples, and depending on the form of the tether 14, the drive pulleys 54 can include teeth or other sprocket features for engaging and gripping the tethers 14. Furthermore, the use of the drive pulleys 52a, 52b having a relatively small diameter can result in a reduction in the torque required to move the load 12. The reduction of the torque requirement can result in the reduction of power output to be supplied by the drive mechanism.

In some particular examples, stainless steel indexing belts can be used as the tethers 14, including, for example but not limited to, indexing belts manufactured by Belt Technologies, Inc. of Agawam, Mass., U.S.A. Indexing belts can provide for suitable traction and positional accuracy, and the load carrying capacity can be relatively high. The load carrying capacity of indexing belts may allow for the use of only two tethers 14 in the system with a single tether 14 on either side (see for example FIG. 4D), rather than four tethers 14 with two tethers 14 on either side.

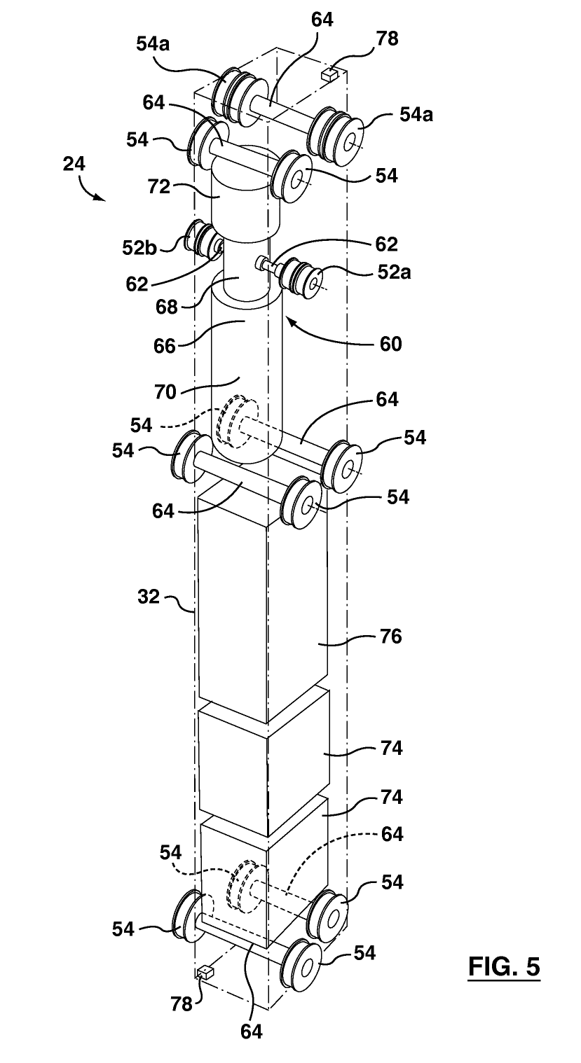

Referring to FIG. 5, the hoist apparatus 24 includes a drive mechanism 60 disposed within the housing 32. The drive pulleys 52a, 52b are driven to rotation by operation of the drive mechanism 60. The drive pulleys 52a, 52b can be driven by the drive mechanism 60 by a common drive axle 62. At least a portion of guide pulleys 54 on opposing sides of the housing 32 can be coupled by a common pulley axle 64.

In some examples, the drive mechanism 60 can include a motor 66, a gear reducer unit 68, a primary braking unit 70 and a secondary braking unit 72. The motor 66 can be an electric motor, and powered by an external power source (e.g., a power cable) or an internal power source (e.g., a battery or a fuel cell). The hoist apparatus 24 can include one or more power units 74 disposed within the housing 32 for storing an internal power source, for example but not limited to, a battery, a fuel cell, ultracapacitors, etc.

The hoist apparatus 24 can also include a control unit 76 adapted to control the operation of the drive mechanism 60. The control unit 76 can be hard-wired and/or can include a wireless communications device (not shown) adapted to receive control signals for controlling the hoist apparatus 24, and transmit signals regarding the hoist apparatus 24. The hoist apparatus 24 can further include at least one distance sensor device 78 adapted to record a distance measurement between the hoist apparatus 24 and, for example, at least one of the connection points 16, 18 or structures 20, 22. The distance sensor device 78 can be, for example, a laser sensor device. The distance sensor device 78 can be operably connected to the control unit 76 so that the control unit 76 can be provided with position information.

In use in a theatre environment, an external computer system (not shown) can be implemented and configured to connect, through cables and/or wirelessly, to the control unit 76 of the hoist apparatus 24. The computer system can transmit command signals to the control unit 76, and optionally can receive position information either from the control unit 76 or by either means (for example, distance sensor devices can be mounted on the structures 20, 22 can be configured to relay position information regarding the hoist apparatuses 24 back to the computer system). A plurality of the hoist apparatuses can be operated in parallel 24. Using the computer system, the hoist apparatuses 24 can be controlled in either an automated or manual, real-time manner.

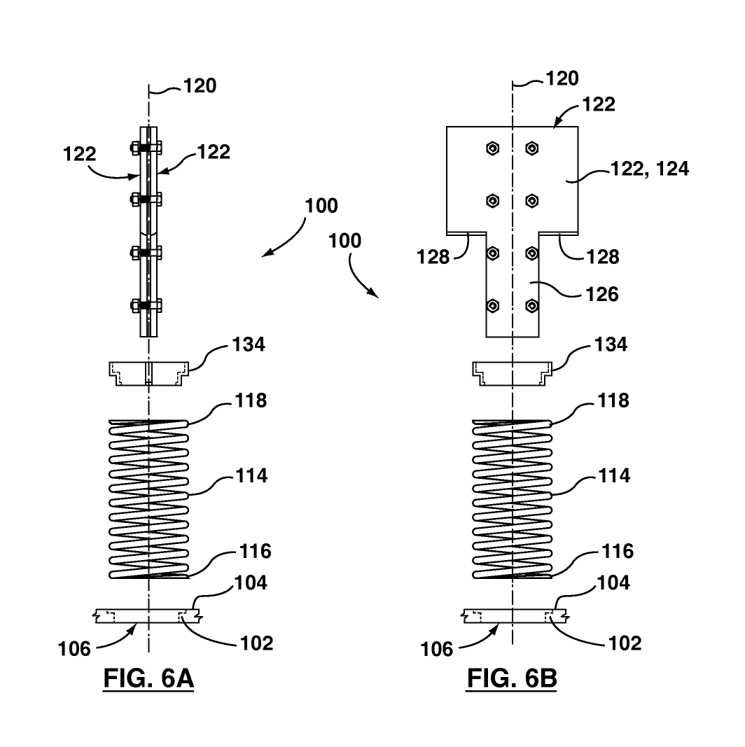

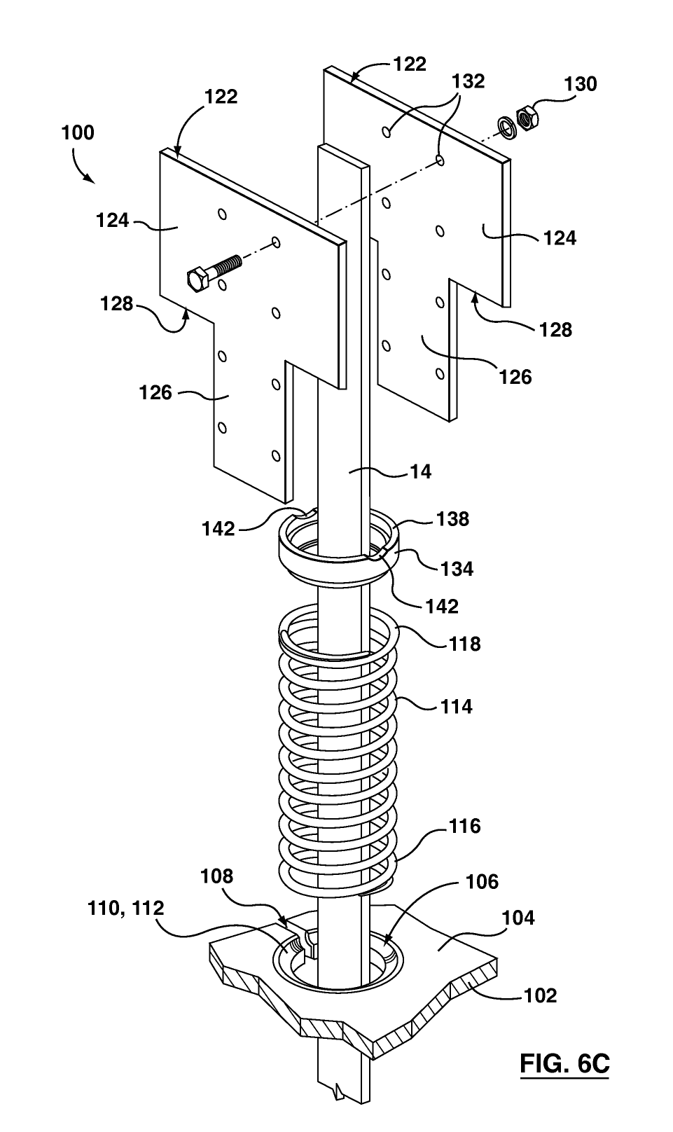

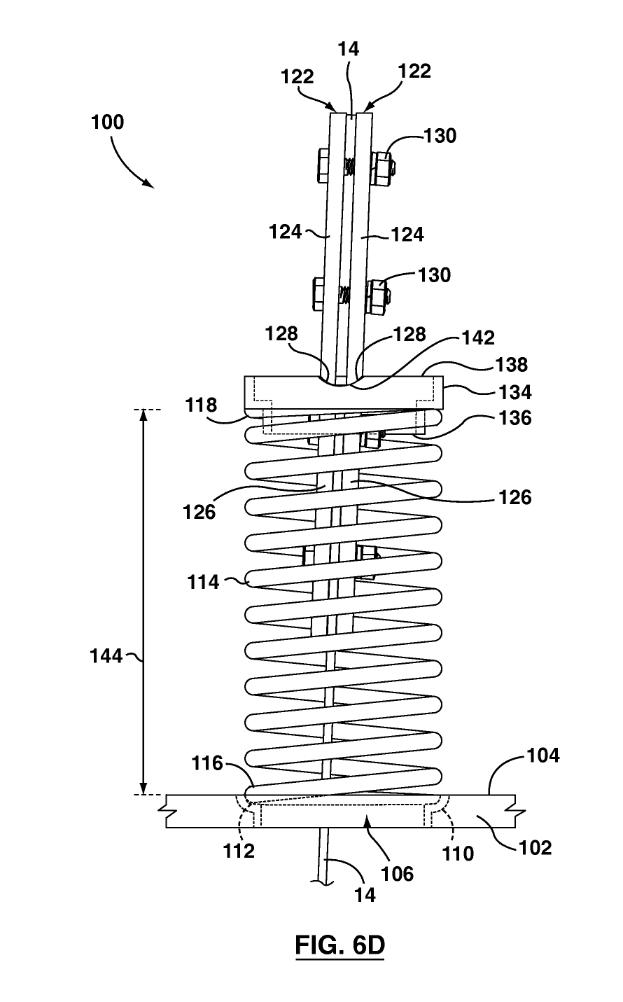

Referring to FIGS. 6A, 6B, 6C and 6D, shown generally at 100 is a connection apparatus for connecting a tether 14 to a fixed surface. The connection apparatus 100 may be suitable for use to couple the tether 14 to the structures 20, 22 in the system 10 described above.

The connection apparatus 100 includes a base plate 102 that can be coupled, directly or indirectly, to a fixed surface. The base plate 102 can include a first side surface 104 and an aperture 106. The base plate 102 can also include an access channel 108, enabling placement of the tether 14 within the aperture 106. The base plate 102 can further include a generally circular first groove 110 on the first side surface 104 surrounding the aperture 106. The base plate 102 can yet further include an insert portion 112 (see FIGS. 6C and 6D). The insert portion 112 can include the first groove 110, and can be formed of a high-strength and resilient material.

The connection apparatus 100 further includes a spring mechanism 114 including first and second ends 116, 118. The spring mechanism 114 can take the form of a coil spring. The first and second ends 116, 118 define a longitudinal axis 120 (see FIGS. 6A and 6B). The second end 118 is positioned spaced apart from the base plate 102 so that the axis 120 is generally orthogonal to the first side surface 104 of the base plate 102 and in general alignment with the aperture 106. The first end 116 bears against the first side surface 104. In particular, the first groove 110 is sized and shaped so that the first end 116 of the spring mechanism 114 can be seated in the first groove 110.

The connection apparatus 100 further includes at least one end plate 122 coupled to the tether 14. The end plate 122 can include a main section 124 and a narrowed section 126. The main section 124 includes flange edges 128 on opposing sides of the narrowed section 126 generally defining a T-shape. The spring mechanism 114 can receive at least a portion of the narrowed section 126 of the end plate 122. As illustrated, two of the end plates 122 can be arranged on either side of the tether 14 and connected to one another to provide a fixed connection to the tether 14. The two end plates 122 can be connected to one another with fasteners 130. The fasteners 130 can be inserted into predrilled holes 132 in the end plates 122, and then tightened to compressively engage the tether 14.

The connection apparatus 100 further includes a bushing member 134 coupling the second end 118 of the spring mechanism 114 to the at least one end plate 122. The bushing member 134 can be generally circular and concentric with the axis 120, and with the tether 14 extending through the bushing member 134. The bushing member 134 can include a first side 136 generally facing the spring mechanism 114 and a second side 138 generally facing the at least one end plate 122. The bushing member 134 can include a generally circular second groove or shoulder 140 on the first side 136. The second groove 140 is sized and shaped so that the second end 118 of the spring mechanism 114 can be seated in the second groove 140.

The bushing member 134 can receive at least a portion of the narrowed section 126 of the end plate 122, either in a loose fit or friction fit arrangement. The bushing member 134 can further include a lateral groove 142 on the second side 138. The lateral groove 142 can be disposed on generally opposing sides of the bushing member 134, and can be sized and shaped so that the flange edges 128 of the at least one end plate 122 can be seated in the lateral groove 142. The lateral groove 142 and the flange edges 128 can be shaped for complementary engagement. For example, as illustrated in FIG. 6D, the lateral groove 142 and the flange edges 128 can have generally arcuate profiles.

With particular reference to FIG. 6D, in an assembled state, the tether 14 extends from the at least one end plate 122 through the bushing member 134, the spring mechanism 114 and the aperture 106. Tension on the tether 14 causes the spring mechanism 114 to compress and reduce a distance 144 between the end and base plates 122, 102.

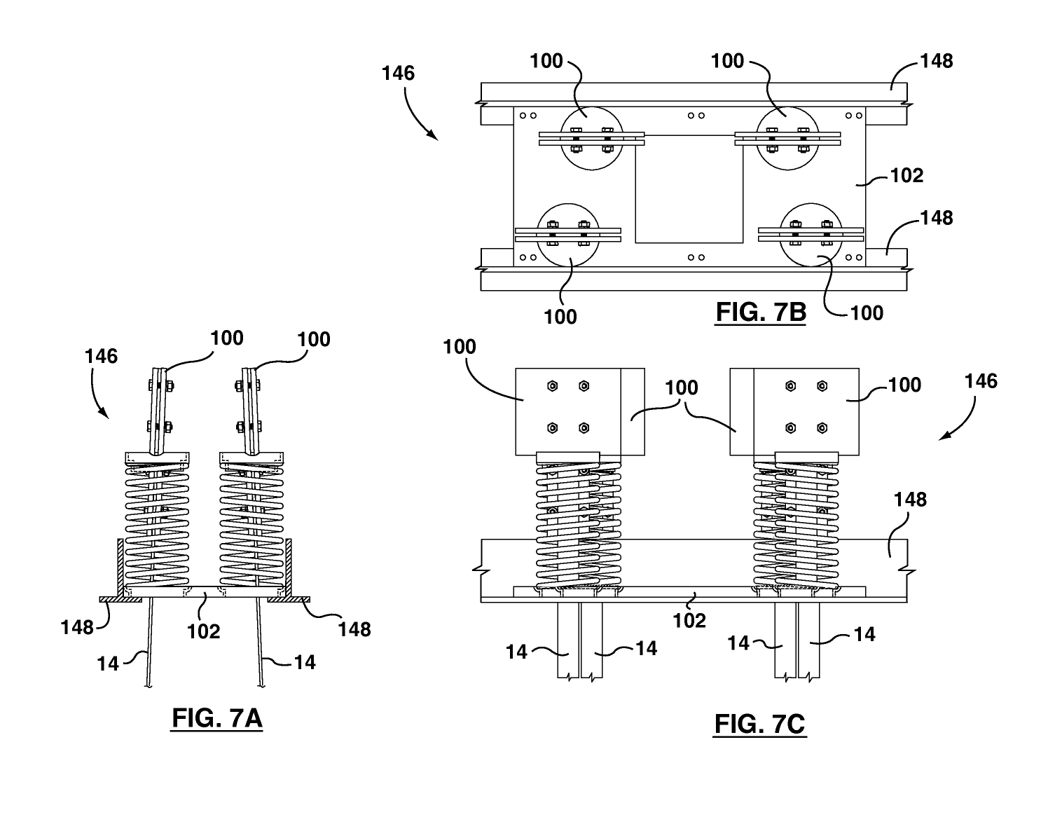

Referring to FIGS. 7A, 7B and 7C, a plurality of the connection apparatuses 100 can be arranged in combination to form an assembly 146. The assembly 146 is configured to couple a plurality of tethers 14 to a fixed surface 148. The fixed surface 148 can be, for example but not limited to, structural beam members. As illustrated, the base plate 102 can be common for each of the connection apparatuses 100.

The assembly 146 can be suitable for use as the connection points 16, 18 for coupling the tethers 14 to the structures 20, 22 in the system 10 described above. When implemented in the system 10, the spring mechanism 114 of each of the connection apparatuses 100 can at least partially absorb or dampen force transmitted through the tethers 14 caused by movement of the hoist apparatus 24.

Although this specification describes systems and apparatuses for that have particularly useful application to the field of theatrical stage rigging, it should be appreciated that other applications of the teachings herein are possible.

While the above description provides examples of one or more processes or apparatuses, it will be appreciated that other processes or apparatuses may be within the scope of the accompanying claims.

I claim:

1. A rigging system for raising and lowering a load, the system comprising:
at least one tether suspended between first and second spaced apart connection points;
a hoist apparatus, the hoist apparatus including a housing and a drive mechanism disposed within the housing, the drive mechanism coupled to the at least one tether, the hoist apparatus being selectively movable along the at least one tether by operation of the drive mechanism; and
at least one connection line coupling the hoist apparatus and the load such that movement of the hoist apparatus towards and away from the first connection point respectively causes the raising and lowering of the load.

2. The system of claim 1, wherein the hoist apparatus further comprises at least one drive pulley mounted on the housing and operably connected to the at least one tether, the drive pulley driven to rotation by operation of the drive mechanism.

3. The system of claim 2, wherein the at least one tether comprises first and second tethers, and the drive pulley is operably connected to each of the first and second tethers.

4. The system of claim 3, wherein the hoist apparatus further comprises at least first and second guide pulleys operably connected to the first and second tethers, respectively.

5. The system of claim 4, wherein the guide pulleys are arranged laterally offset relative to the drive pulley so that the guide pulleys maintain the first and second tethers spaced apart from one another above and below the hoist apparatus.

6. The system of claim 5, wherein the first tether extends along a first linear path from the first connection point to the hoist apparatus, and along a second linear path from the hoist apparatus to the second connection point.

7. The system of claim 6, wherein the second tether extends generally along the second linear path from the first connection point to the hoist apparatus, and generally along the first linear path from the hoist apparatus to the second connection point.

8. The system of claim 2, wherein the at least one drive pulley comprises first and second drive pulleys, the first and second drive pulley extending outwardly from left and right sides of the housing, respectively.

9. The system of claim 8, wherein the at least one tether comprises first, second, third and fourth tethers, the first drive pulley is operably connected to the first and second tethers extending along the right side of the housing and the second drive pulley is operably connected to the third and fourth tethers extending along the left side of the housing.

10. The system of claim 9, wherein the hoist apparatus further comprises a plurality of first and second guide pulleys respectively mounted to the right and left sides of the housing and each operably connected to at least one of the tethers.

11. The system of claim 10, wherein the first guide pulleys are arranged laterally offset relative to the first drive pulley so that the first guide pulleys maintain the first and second tethers spaced apart from one another above and below the hoist apparatus, and the second guide pulleys are arranged laterally offset relative to the second drive pulley so that the second guide pulleys maintain the third and fourth tethers spaced apart from one another above and below the hoist apparatus.

12. The system of claim 11, wherein the first tether extends along a first linear path from the first connection point to the hoist apparatus, and along a second linear path from the hoist apparatus to the second connection point, the second tether extends generally along the second linear path from the first connection point to the hoist apparatus, and generally along the first linear path from the hoist apparatus to the second connection point.

13. The system of claim 12, wherein the third and fourth tethers are arranged in a generally mirror image relationship relative to the first and second tethers.

14. The system of claim 8, wherein the first and second drive pulleys are driven by the drive mechanism by a common drive axle.

15. The system of claim 10, wherein at least a portion of the first and second guide pulleys are coupled by a common pulley axle.

16. The system of claim 1, wherein the drive mechanism comprises an electric motor.

17. The system of claim 17, wherein the electric motor is powered by at least one of a power cable, a battery, a fuel cell, and an ultracapacitor.

18. The system of claim 1, wherein the hoist apparatus further comprises at least one distance sensor device adapted to record a distance measurement between the hoist apparatus and at least one of the first or the second connection points, and the at least one distance sensor device is operably connected to a control unit adapted to control the operation of the drive mechanism.

19. The system of claim 18, wherein the control unit comprises a wireless communications device adapted to at least one of receive and transmit control signals regarding the hoist apparatus.

20. A connection apparatus for connecting a tether to a fixed surface, the apparatus comprising:
a base plate coupled to the fixed surface, the base plate including a first side surface and an aperture extending through the base plate;
a spring mechanism including first and second ends and defining a longitudinal axis between the first and second ends, the first end configured to bear against the first side surface of the base plate, the second end positioned spaced apart from the base plate so that the longitudinal axis is in general alignment with the aperture; and
at least one end plate arranged adjacent to the second end of the spring mechanism and coupled to the tether, the tether extending from the at least one end plate through the spring mechanism and the aperture,
wherein tension on the tether causes the spring mechanism to compress and reduce distance between the end and base plates.

21. The apparatus of claim 20, wherein the base plate comprises a generally circular first groove on the first side surface surrounding the aperture, and the first end of the spring mechanism is seated in the first groove.

22. The apparatus of claim 21, further comprising a bushing member coupling the second end of the spring mechanism to the at least one end plate, the bushing member including a first side generally facing the spring mechanism and a second side generally facing the end plate, the end plate configured to bear against the second side of the bushing member.

23. The apparatus of claim 22, wherein the bushing member is generally cylindrical and generally concentric with the longitudinal axis.

24. The apparatus of claim 23, wherein the bushing member includes a generally circular second groove on the first side, and the second end of the spring mechanism is seated in the second groove.

25. The apparatus of claim 24, wherein the at least one end plate comprises a main section and a narrowed section, the main section comprising flange edges on opposing sides of the narrowed section generally defining a T-shape, and the spring mechanism receives at least a portion of the narrowed section of the end plate.

26. The apparatus of claim 25, wherein the bushing member includes a lateral groove on the second side, and the flange edges of the end plate are seated in the lateral groove.

27. The apparatus of claim 26, wherein the lateral groove and the flange edges are shaped for complementary engagement.

28. The apparatus of claims 20, wherein the at least one end plate comprises two end plates arranged on either side of the tether and connected to one another to provide a fixed connection to the tether.

29. The apparatus of claim 28, wherein the two end plates are connected to one another with fasteners, and the fasteners are tightened to compressively engage the tether.

30. The apparatus of claim 20, wherein the spring mechanism comprises a coil spring.

31. In combination, a plurality of the apparatus of claim 20 arranged in an assembly, wherein the base plate is common for each of the apparatuses.
